(19) United States
(12) Patent Application Publication
(10) Pub. No.: US 2025/0308337 A1
(43) Pub. Date: Oct. 2, 2025

(54) SIMPLIFIED SPORTS BETTING SYSTEM AND METHOS

(71) Applicant: Vincent Brie, Westmount (CA)

(72) Inventor: Vincent Brie, Westmount (CA)

(21) Appl. No.: 18/793,773

(22) Filed: Aug. 3, 2024

Related U.S. Application Data
(60) Provisional application No. 63/571,661, filed on Mar. 29, 2024.

(51) Int. Cl. G07F 17/32; G06Q 50/34

(52) U.S. Cl. CPC G07F 17/3288; G06Q 50/34; G07F 17/323; G07F 17/3223

(57) ABSTRACT

A simplified sports betting system and method is disclosed, designed for both online and physical betting environments. The system presents pre-packaged bet options to users, each including a fixed bet amount, potential winning amount, and unique identifier. This approach eliminates the need for users to interpret complex odds or perform calculations. In online platforms, users select bets through web or mobile interfaces. In physical locations, large displays show pre-packaged bets, allowing customers to place bets by referencing simple identifiers to tellers or via self-service kiosks. The system dynamically updates potential winnings based on real-time odds data, maintaining accuracy while preserving a user-friendly interface. The betting process is streamlined to selecting a pre-packaged bet, confirming the selection, and receiving a receipt. This invention simplifies sports betting, making it more accessible to a broader audience while maintaining essential wagering elements, potentially expanding the market for sports betting.

### FIELD

The present invention relates generally to the field of sports betting systems and methods. More specifically, the invention pertains to a simplified and user-friendly approach for displaying and placing sports bets through various platforms, including online interfaces, mobile applications, and physical betting locations.

### BACKGROUND

Sports betting has traditionally been a complex activity, often requiring participants to understand intricate odds systems, betting terminologies, and mathematical calculations. This complexity has created a significant barrier to entry for casual or novice bettors, potentially limiting the market for sports betting activities.

Conventional sports betting interfaces, whether digital or physical, typically display a wealth of information including team names, various types of odds (e.g., American, decimal, or fractional), and additional statistical data. While comprehensive, this presentation can be overwhelming and confusing to many users.

Furthermore, the process of placing a bet often involves multiple steps, such as selecting a sport, choosing a specific event, understanding the type of bet, interpreting the odds, deciding on a wager amount, and finally placing the bet. Each of these steps requires a degree of familiarity with sports betting conventions, creating a significant cognitive load for users.

Despite technological advancements in online and mobile betting platforms, many of these fundamental complexities remain, often simply translating the traditional betting board to a digital format without addressing the underlying usability issues.

There exists a need for a sports betting system that simplifies the betting process, making it more accessible to a broader audience while maintaining the essential excitement and engagement of sports wagering.

### SUMMARY

The present invention addresses the limitations of traditional sports betting systems by providing a simplified method and system for displaying and placing sports bets. This invention is designed to be implemented across various platforms, including web browsers, mobile applications, and physical betting locations.

Key aspects of the invention include:
1. Pre-packaged Bets: The system presents users with pre-packaged bet options, each displaying a fixed bet amount and the corresponding potential winning amount. This eliminates the need for users to calculate odds or understand complex betting terminology.
2. Simplified User Interface: The betting process is streamlined, typically requiring only three steps: selecting a pre-packaged bet, confirming the selection, and receiving a confirmation receipt.
3. Dynamic Odds Integration: While simplifying the user interface, the system maintains connection with real-time odds data. The potential winning amounts are automatically updated based on current odds, ensuring users always see accurate, up-to-date information.
4. Multi-Platform Compatibility: The invention is designed to function seamlessly across various platforms, including web browsers, mobile applications, and physical betting locations, providing a consistent user experience regardless of the access point.
5. Physical Location Implementation: For in-person betting scenarios, the invention includes a numbered bet system where pre-packaged bets are displayed on screens with corresponding numbers. Bettors can simply reference these numbers when placing bets with tellers or at kiosks.
6. Self-Service Kiosks: The system supports self-service betting kiosks in physical locations, further streamlining the betting process.

By simplifying the betting process and presenting information in an easily digestible format, this invention aims to make sports betting more accessible to a broader audience, potentially expanding the market while maintaining the essential excitement of sports wagering.

The following detailed description and accompanying drawings will provide a more comprehensive understanding of the invention's features, functionalities, and advantages.

### BRIEF DESCRIPTION OF THE DRAWINGS

FIG. 1A-1C are user interface diagrams illustrating typical screens of a traditional sportsbook, representing prior art.

FIG. 2A-2B are user interface diagrams showing screens of the simplified sports betting system according to the present invention.

FIG. 3 is a diagram depicting a traditional physical sportsbook setup and betting process, representing prior art.

FIG. 4 is a diagram illustrating the simplified physical sportsbook setup and betting process according to the present invention.

FIG. 5 is a schematic diagram illustrating the overall system architecture for the sports betting system, including remote and online components.

FIG. 6 is a schematic diagram showing the setup for a physical betting location, including local network and display components.

FIG. 7 is a flowchart depicting the online betting process, showing both customer actions and system responses.

FIG. 8 is a flowchart illustrating the betting process in a physical location, including customer actions and sportsbook responses.

### DETAILED DESCRIPTION OF THE INVENTION

The present invention provides a novel method and system for simplifying sports betting across various platforms. This description, in conjunction with the accompanying drawings, sets forth the best mode contemplated for carrying out the invention.

### Comparison with Prior Art

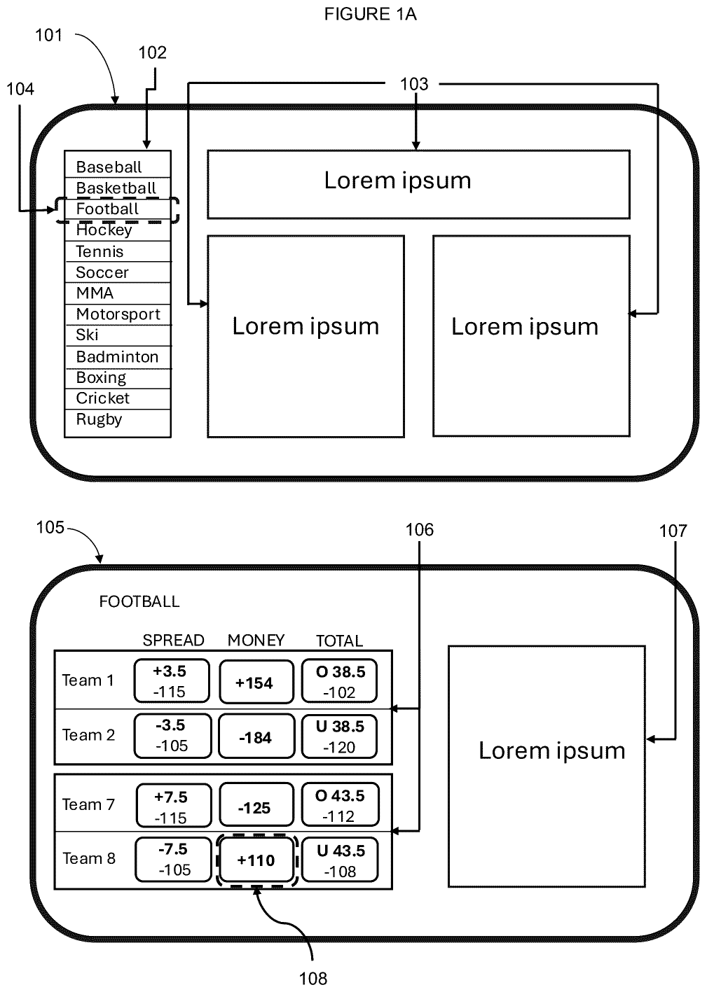

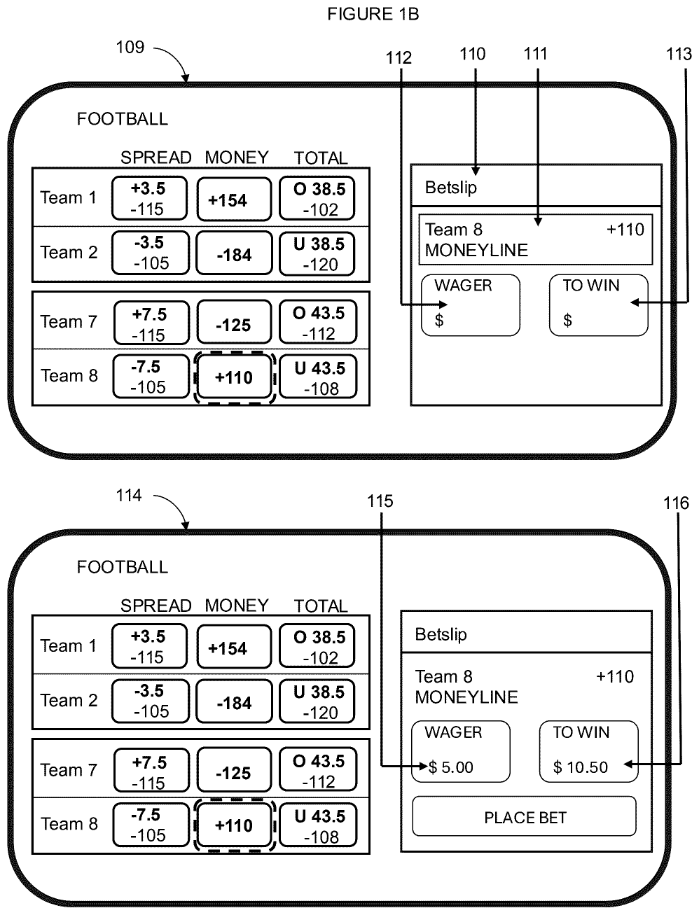

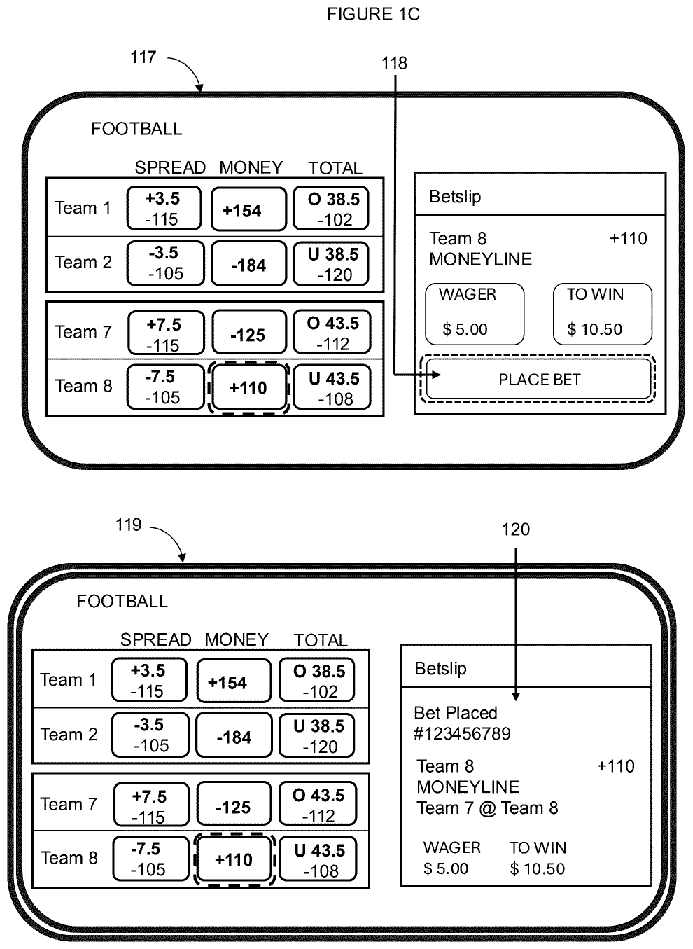

Online Betting Prior Art: Referring to FIGS. 1A, 1B, and 1C, traditional online sportsbook interfaces are illustrated. FIG. 1A shows a typical sports selection screen (101) with a multitude of sports options (102) and additional information areas (103, 104). FIG. 1B depicts a standard betting screen for a selected sport, in this case, football (109). It displays complex betting options including spread, money line, and totals (110-113), requiring users to understand various odds formats and betting types. FIG. 1C further illustrates the complexity by showing a betslip (117, 119) where users must input their wager amount and interpret potential winnings based on odds.

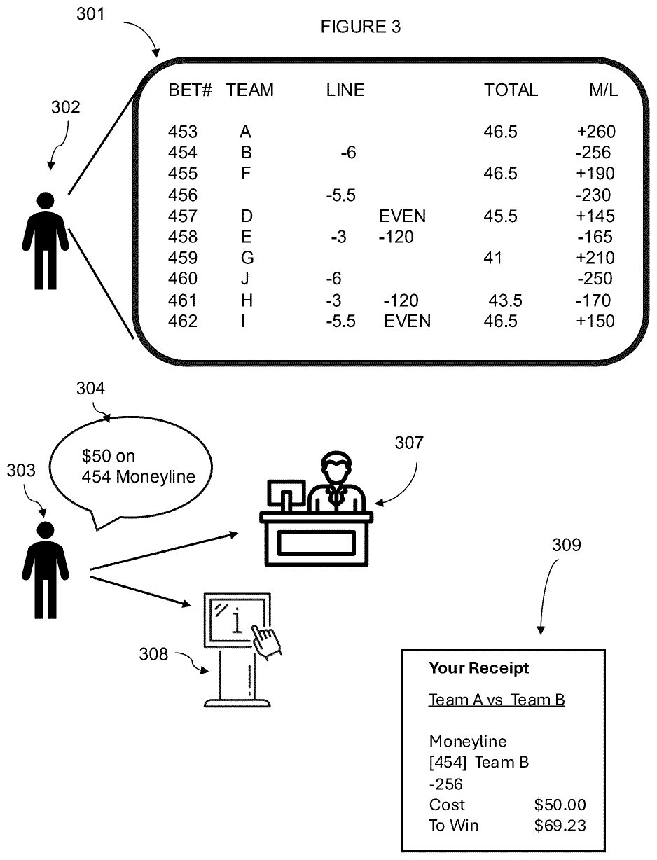

Physical Location Prior Art: Referring now to FIG. 3, a traditional physical sportsbook environment is illustrated. The figure shows a complex betting board (301) displaying a multitude of numbers and odds formats. Customers (302) must decipher this information, which includes bet numbers, team names, lines, totals, and money line odds. To place a bet, a customer (303) must communicate their bet using specific terminology and bet numbers (304) to a teller (307) or via a self-service kiosk (308). The resulting bet slip (309) contains complex information that may be difficult for novice bettors to understand.

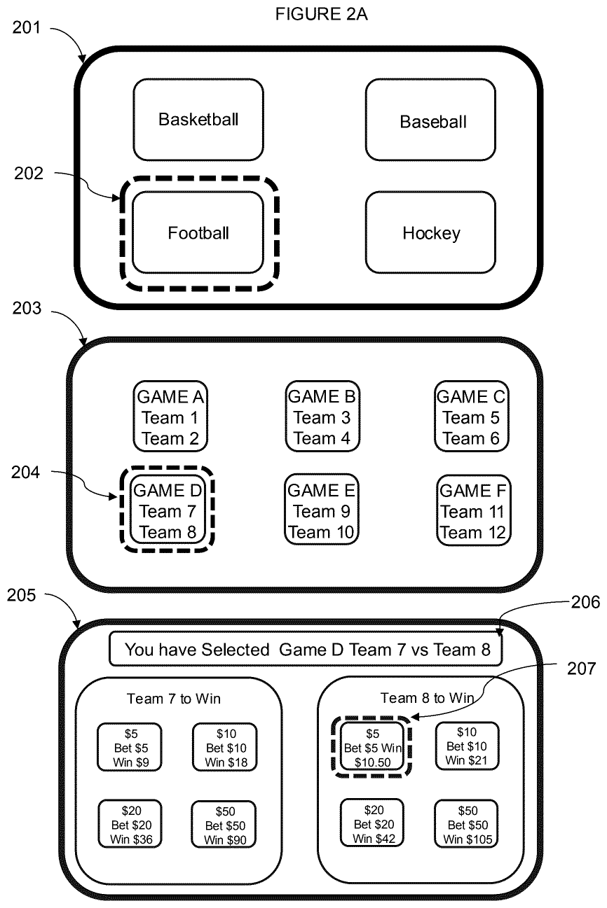

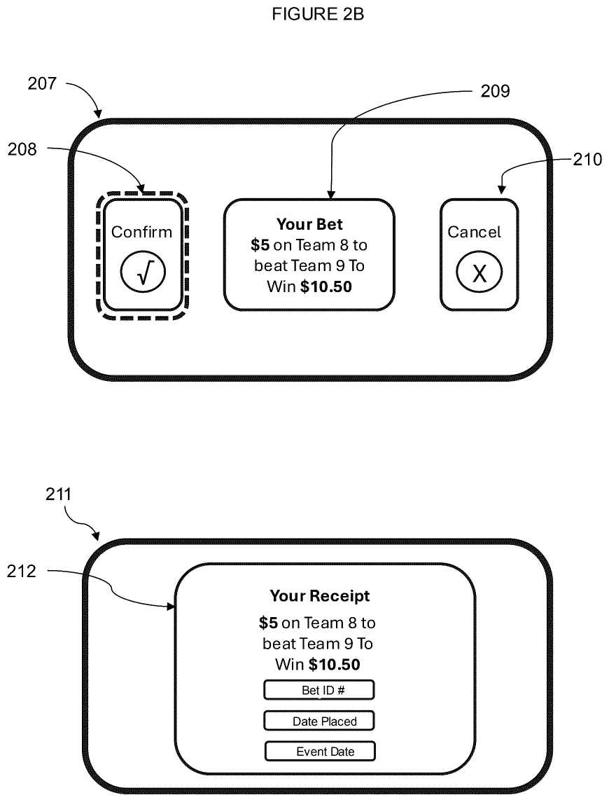

Present Invention—Online Interface: In contrast, FIGS. 2A-2B demonstrate the simplified interface of the present invention for online betting. FIG. 2A shows a streamlined sport selection screen (201) and game selection screen (203). FIG. 2B illustrates the simplified betting options (207), where users are presented with clear, pre-packaged bets showing exact stake amounts and potential winnings (209).

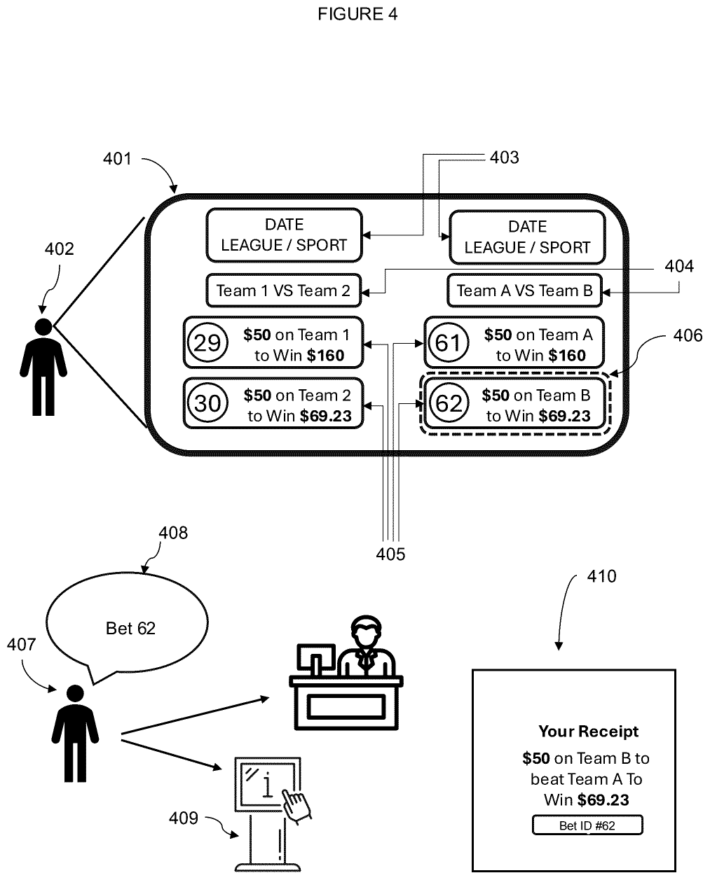

Present Invention—Physical Location: FIG. 4 shows the simplified physical sportsbook setup of the present invention. Large displays (401) present clear, pre-packaged bets with unique identifiers (403, 404, 405, 406). Each pre-packaged bet shows a fixed bet amount and the potential winnings, eliminating the need for customers to interpret complex odds. Customers (402) can easily place bets by referencing these simple bet numbers (408) to a teller or via a self-service kiosk (409). The resulting receipt (410) is straightforward and easy to understand, showing the bet amount, the teams involved, and the potential winnings.

### System Architecture

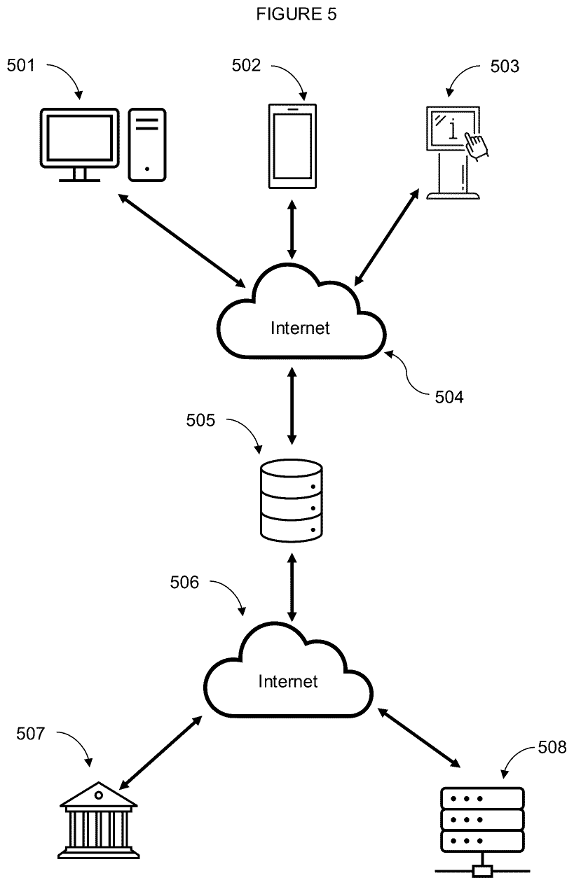

FIG. 5 illustrates the overall system architecture of the present invention. The system comprises multiple user interfaces, including desktop computers (501), mobile devices (502), and remote kiosks (503), all connected via the Internet (504) to a central database (505). The central database is further connected to another Internet cloud (506), which interfaces with financial institutions (507) and odds providers (508). This structure allows for real-time updating of odds and seamless processing of financial transactions.

### Physical Location Setup

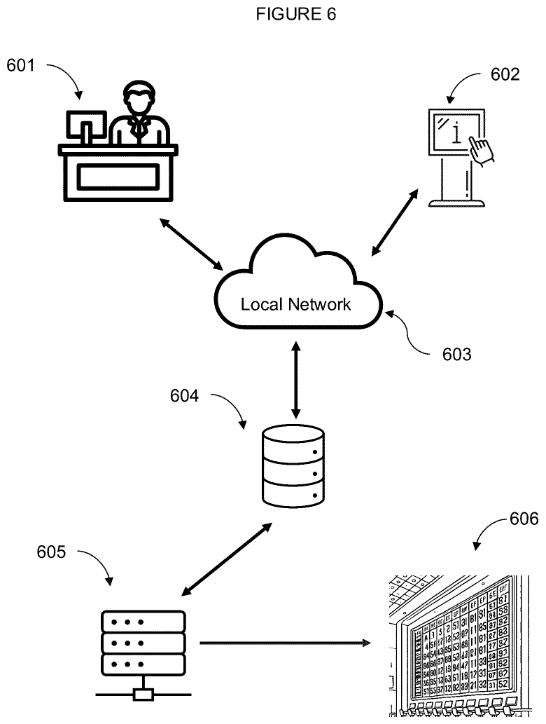

FIG. 6 illustrates the setup for a physical betting location. The system includes betting windows with human tellers (601), self-service kiosks (602), all connected via a local network (603) to a local database (604). A local server (605) manages the system and communicates with large display boards (606) showing current betting options.

### Online Betting Process

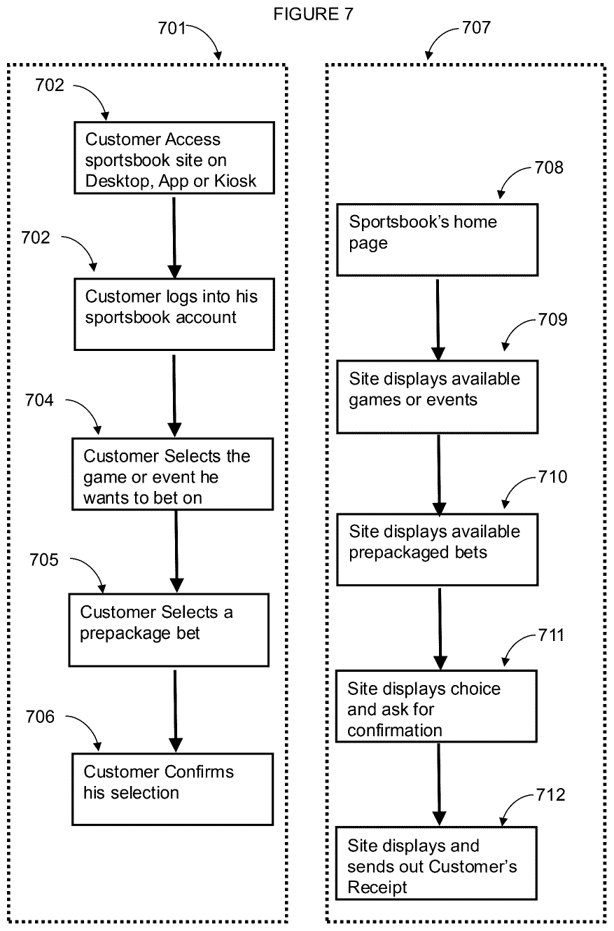

FIG. 7 demonstrates the online betting process. The left side (701) shows the customer's actions, while the right side (707) displays the corresponding system responses. The process begins with the customer accessing the sportsbook site (702) and logging into their account (703). The customer then selects a game or event (704) and chooses a pre-packaged bet (705). Finally, the customer confirms their selection (706). The system responds by displaying the home page (708), available games (709), pre-packaged bets (710), and a confirmation request (711) before issuing a receipt (712).

### Physical Location Betting Process

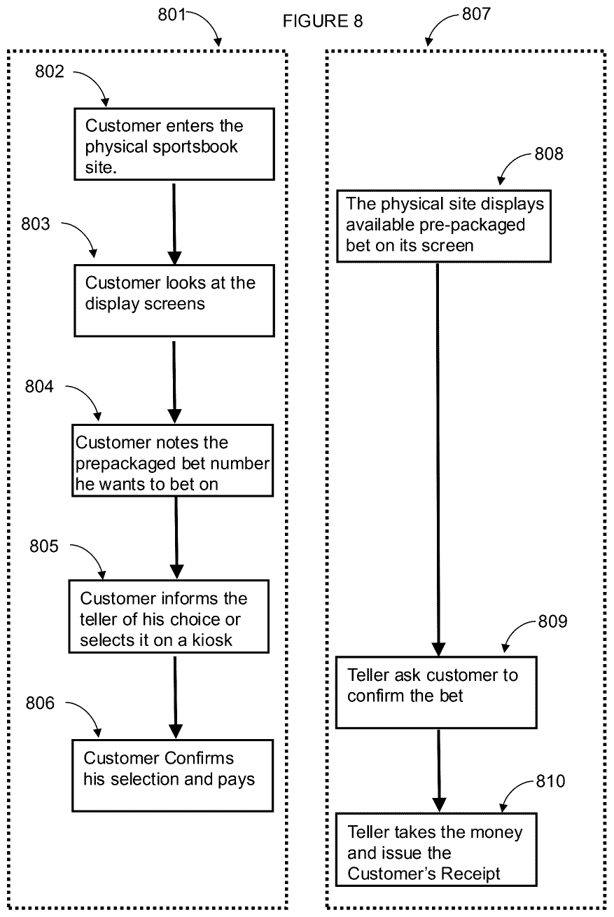

FIG. 8 outlines the betting process in a physical location. The left side (801) shows the customer's actions, while the right side (807) displays the sportsbook's actions. The process begins when the customer enters the physical sportsbook site (802). The customer then looks at the display screens (803) and notes the prepackaged bet number they want to bet on (804). The customer informs the teller of their choice or selects it on a kiosk (805), and then confirms their selection and pays (806). On the sportsbook side, the physical site displays available pre-packaged bets on its screens (808). The teller asks the customer to confirm the bet (809), and upon confirmation, takes the money and issues the customer's receipt (810). This streamlined process significantly simplifies the betting experience in physical locations compared to traditional methods.

The system is designed to be easily scalable and adaptable to various sports and betting types. Administrators can create and modify pre-packaged bets through a dedicated interface, allowing for quick responses to market demands or regulatory changes.

### Exemplary Embodiment

In one embodiment of the invention, the system is implemented as follows:

The central server (505) runs on a cloud-based infrastructure, utilizing distributed computing resources for scalability and reliability. This server hosts the main database, which stores user accounts, bet histories, and current odds.

User interfaces are developed as responsive web applications, compatible with both desktop (501) and mobile (502) browsers. Additionally, a native mobile app is developed for iOS and Android platforms. Self-service kiosks (503) in physical locations run a specialized version of this web application optimized for touch screens.

The system interfaces with financial institutions (507) through secure API connections, allowing for real-time processing of deposits and withdrawals. Odds data is received from established odds providers (508) via high-speed, encrypted data feeds.

The algorithm for generating pre-packaged bets runs on the central server. It considers current odds, betting trends, and predetermined profit margins to create a variety of bet options. These options are updated in real-time as odds change.

In physical locations, local servers (605) connect to the central system via a secure VPN. These servers manage local databases (604) that mirror relevant portions of the central database, ensuring fast response times and continued operation in case of temporary internet outages. Large LED displays (606) in the physical locations are updated in real-time with current pre-packaged bet options.

This embodiment demonstrates how the various components of the system work together to provide a seamless, simplified betting experience across both online and physical platforms.

### Implementation Steps

To implement this invention, one would need to:
1. Set up the central server and database system (505 in FIG. 5).
2. Develop user interfaces for web, mobile, and kiosk platforms (501, 502, 503 in FIG. 5).
3. Establish connections with financial institutions (507 in FIG. 5) and odds providers (508 in FIG. 5).
4. Create the algorithm for generating and updating pre-packaged bets.
5. Implement the local network (603 in FIG. 6) and display systems (606 in FIG. 6) for physical locations.
6. Develop the software for the betting process flow in both online (FIG. 7) and physical (FIG. 8) environments.
7. Design and implement the simplified user interfaces for both online (FIGS. 2A-2B) and physical (FIG. 4) betting.

This invention simplifies sports betting while maintaining its essential elements, making it more accessible to a broader audience and potentially expanding the market for sports wagering.

1. A method for facilitating sports betting, comprising:
a) displaying a plurality of pre-packaged bet options on a user interface, each pre-packaged bet option including a fixed bet amount, a potential winning amount, and a unique identifier;
b) receiving a user selection of one of said pre-packaged bet options via the unique identifier;
c) processing said selection to place a bet; and
d) providing a confirmation receipt to the user.

2. The method of claim 1, wherein said user interface is implemented on at least one of:
a web platform, a mobile application, a physical display in a betting location, and a self-service kiosk.

3. The method of claim 1, further comprising dynamically updating the potential winning amount of each pre-packaged bet option based on real-time odds data.

4. The method of claim 1, wherein in a physical betting location, receiving a user selection comprises receiving said unique identifier from a teller or via a self-service kiosk.

5. A system for facilitating sports betting, comprising:
a) a display configured to show a plurality of pre-packaged bet options, each including a fixed bet amount, a potential winning amount, and a unique identifier;
b) a user input device for selecting a pre-packaged bet option via the unique identifier;
c) a processor configured to process the selected bet and generate a bet confirmation; and
d) a network interface for receiving real-time odds data and updating the displayed potential winning amounts.

6. The system of claim 5, wherein the display is a large screen in a physical betting location, and the user input device is at least one of a self-service kiosk and a teller-operated terminal.

7. The system of claim 5, wherein the display and user input device are implemented on a mobile device or personal computer connected to the processor via the Internet.

8. A method for presenting sports betting options, comprising:
a) displaying a selection of sports categories;
b) upon selection of a sports category, displaying a list of available games or events within that category;
c) upon selection of a game or event, displaying a set of pre-packaged bet options, each option including a fixed bet amount, a calculated potential winning amount, and a unique identifier; and
d) updating the displayed potential winning amounts in real-time as odds data changes.

9. The method of claim 8, further comprising receiving a user selection of a displayed pre-packaged bet option via its unique identifier and processing said selection to place a bet.

10. A non-transitory computer-readable medium storing instructions that, when executed by a processor, cause the processor to perform a method comprising:
a) generating a simplified betting interface displaying pre-packaged bet options, each option including a fixed bet amount, a potential winning amount, and a unique identifier;
b) receiving a user selection of a pre-packaged bet option via the unique identifier;
c) processing the selected bet option to place a bet; and
d) providing a confirmation of the placed bet.
